(19) United States
(12) Patent Application Publication
(10) Pub. No.: US 2011/0174710 A1
(43) Pub. Date: Jul. 21, 2011

(54) SEPARATING DEVICE FOR SEPARATING MAGNETIZABLE PARTICLES AND NON-MAGNETIZABLE PARTICLES TRANSPORTED IN A SUSPENSION FLOWING THROUGH A SEPARATING CHANNEL

(76) Inventors: Werner Hartmann, Weisendorf (DE); Bernd Trautmann, Erlangen (DE)

(21) Appl. No.: 13/119,082

(22) PCT Filed: Sep. 1, 2009
(86) PCT No.: PCT/EP2009/061250

§ 371 Date: Mar. 15, 2011

(30) Foreign Application Priority Data
Sep. 18, 2008 (DE) 10 2008 047 843.1

(51) Int. Cl. B03C 1/02

(52) U.S. Cl. 210/222

(57) ABSTRACT

A separating device (1, 10, 11) for separating magnetizable particles and non-magnetizable particles transported in a suspension flowing through a separating channel (3), has at least one permanent magnet (4) arranged on at least one side of the separating channel (3) for producing a magnetic field which deflects magnetizable particles to the side, wherein in addition to the permanent magnet (4) at least one coil (7) is provided for producing an additional field.

### CROSS-REFERENCE TO RELATED APPLICATIONS

This application is a U.S. National Stage Application of International Application No. PCT/EP2009/061250 filed Sep. 1, 2009, which designates the United States of America, and claims priority to DE Application No. 10 2008 047 843.1 filed Sep. 18, 2008. The contents of which are hereby incorporated by reference in their entirety.

### TECHNICAL FIELD

The invention relates to a separating device for separating magnetizable particles and non-magnetizable particles transported in a suspension flowing through a separating channel, having at least one permanent magnet arranged on at least one side of the separating channel for generating a magnetic field which deflects magnetizable particles to said side.

### BACKGROUND

In particular in the area of ore extraction or scrap separation, it is often desired to separate non-magnetizable particles from magnetizable particles in a process that is as simple as possible. It has been proposed for this purpose to pass a suspension which contains the magnetizable particles and non-magnetizable particles through a separating channel. At the same time, a deflecting magnetic field is generated by a magnetic field generating means, which is arranged adjacent to the separating channel, with the intention that said field has not only a sufficiently high field strength but also a sufficiently high magnetic field gradient, as far as possible over the entire separating channel, since the force acting on a magnetizable particle is in a scalar relationship with both. In this deflecting magnetic field, magnetizable particles consequently experience a force which deflects them, for example to the side of the magnetic field generating means. It is intended in this way to achieve a separation of the particles.

It has been proposed in this respect to use a coil as the magnetic field generating means. In order to generate sufficiently effective magnetic fields, very high currents must be made to flow through the coil. This leads to an immense energy consumption, but also to an undesired rise in temperature, putting the functional capability of the separating device at risk. It has therefore been proposed to use as the magnetic field generating means a permanent magnet, for the operation of which no current is required. However, a disadvantage of this is that a strong concentration of the magnetizable particles builds up in the vicinity of the permanent magnet, hindering or even preventing the flow-through. In the worst case, the permanent magnet must be removed or the accumulation of the magnetizable particles has to be removed by mechanical means. This results in a discontinuous process, which has to be stopped at regular intervals.

### SUMMARY

According to various embodiments, a separating device can be provided that is improved in comparison with this.

According to an embodiment, a separating device for separating magnetizable particles and non-magnetizable particles transported in a suspension flowing through a separating channel, may have at least one permanent magnet arranged on at least one side of the separating channel for generating a magnetic field which deflects magnetizable particles to said side, wherein, in addition to the permanent magnet, at least one coil is provided for generating an additional field.

According to a further embodiment, the coil may be such that current can be made to flow through it to generate a magnetic field that strengthens the deflecting magnetic field. According to a further embodiment, the coil may be such that current can be made to flow through it to generate a magnetic field that weakens the deflecting magnetic field. According to a further embodiment, the or a coil can be arranged so as to surround the permanent magnet. According to a further embodiment, the or a coil can be arranged around a yoke connected to the permanent magnet. According to a further embodiment, the or a coil can be arranged on the yoke on a side of the separating channel that is opposite from the permanent magnet. According to a further embodiment, a control device can be provided for controlling the coil. According to a further embodiment, at least one sensor can be provided, connected to the control device and detecting a clumping or accumulation of magnetizable particles in the separating channel, the control device being designed to make a current flow through the coil to weaken the deflecting magnetic field in response to a signal indicating clumping or accumulation. According to a further embodiment, a magnetizable element, in particular a plate, can be arranged between the permanent magnet and the separating channel. According to a further embodiment, the element may have a convexly curved or trapezoidal form toward the separating channel. According to a further embodiment, a surface of the permanent magnet that is facing the separating channel may have a convexly curved or trapezoidal form.

### BRIEF DESCRIPTION OF THE DRAWINGS

Further advantages and details emerge from the exemplary embodiments described below and on the basis of the drawings, in which:

FIG. 1 shows a basic diagram of a first exemplary embodiment of a separating device,

FIG. 2 shows a basic diagram of a second exemplary embodiment of a separating device,

FIG. 3 shows a basic diagram of a third exemplary embodiment of a separating device, and

FIG. 4 shows a diagram indicating further possible coil positions.

### DETAILED DESCRIPTION

According to various embodiments, in addition to the permanent magnet, at least one coil is provided for generating an additional magnetic field.

According to various embodiments, a combination of at least one coil and at least one permanent magnet is proposed for operating the separating device. While it is possible in principle that the coil is such that current can be made to flow through it to generate a magnetic field that strengthens the deflecting magnetic field, so that, as it were, the proportion contributed by the permanent magnet causes less energy to be consumed and a weakening of the field can be achieved by switching off the coil, it may be provided with particular advantage that the coil is such that current can be made to flow through it to generate a magnetic field that weakens the deflecting magnetic field of a permanent magnet. A combination of both types of operation can be used particularly advantageously.

In each of the cases mentioned here, less energy is required in comparison with a separating device that is only operated by a coil, so that there is also a smaller rise in temperature. In comparison with an arrangement only having a permanent magnet, there is the possibility of controlling the field according to requirements, that is to say strengthening or weakening it. Such strengthening of the deflecting magnetic field may be advisable, for example, whenever larger particles with greater mass inertia are to be separated or a higher flow rate of the suspension is intended.

If the coil is such that current can be made to flow through it to generate a magnetic field that weakens the deflecting magnetic field, a series of further advantages are obtained. For instance, it is possible when deposits are present or at regular intervals to weaken the deflecting magnetic field in such a way that the accumulated magnetizable particles can break up again to the extent that they are transported away by the flow. In this way, a continuous process can be realized. In particular, flow of current is then in principle only absolutely necessary in the portions in which such a weakening, and therefore break-up of accumulations, is intended to take place. In this respect, it should already be noted at this point that the concern here is not the—in any case scarcely possible—complete equalization of the field of the permanent magnet, but the weakening thereof in the relevant regions, that is to say inside the separating channel.

Several possibilities for the arrangement of the coil are possible within the scope of the present process. For instance, on the one hand it may be provided that the or one coil is arranged so as to surround the or at least one permanent magnet. In this way, the deflecting magnetic field generated by the permanent magnet can be influenced virtually “in situ”. This makes a particularly wide working range possible.

As an alternative or in addition, it may be provided that the or one coil is arranged around a yoke connected to the permanent magnet. Such a yoke is usually provided to close the magnetic circuit with respect to the other side of the separating channel or with respect to other permanent magnets. It consequently transports part of the field strength, and therefore serves in principle for strengthening the magnetic field prevailing in the separating channel. Arrangement of one or more coils on the yoke allows this effect to be both increased and reduced, in particular eliminated.

In an expedient configuration, it may also be provided that the or a coil is arranged on the yoke on a side of the separating channel that is opposite from the or a permanent magnet. This is so because it has been found that simply arranging the yoke on the side opposite from the permanent magnet, the yoke being formed in particular so as to be symmetrical to the permanent magnet, does not lead to a field distribution that would be obtained with two opposing permanent magnets. The stray field losses due to parts of the magnetic field escaping laterally from the yoke are quite large. A coil lying opposite the permanent magnet can fundamentally improve the field guiding effect at this point, or even take the place of a permanent magnet arranged there. At the same time, the coil is, however, also favorably positioned to generate a weakening magnetic field, which displaces the magnetic field of the opposite permanent magnet as completely as possible out of the separating channel, so that lumps of magnetizable particles can break up.

As already mentioned, there are many advantageous possibilities for controlling the at least one coil on the basis of the desired effects or the operating parameters. Therefore, a control device may be expediently provided for controlling the coil. In particular if the operation of the coil is intended to be dependent on operating parameters or requirements, this device may regulate the current that is made to flow through the coil on the basis of operating parameters and/or user inputs. Thus, for example, in the case of particularly large particles to be separated or a faster flow rate, a strengthening of the deflecting magnetic field may be required. However, there are also many further possibilities for adapting the deflecting magnetic field to the required conditions if a combination of a permanent magnet and a coil is used.

In a particularly advantageous configuration of the separating device, it may be provided that at least one sensor is provided, connected to the control device and detecting a clumping or accumulation of magnetizable particles in the separating channel, the control device being designed to make a current flow through the coil to weaken the deflecting magnetic field in response to a signal indicating clumping or accumulation. If the coil is accordingly intended for weakening the deflecting magnetic field, with a view to making a continuous process possible, in particular, by avoiding clumpings or deposits, it can in the configuration mentioned be switched on according to requirements as soon as a clumping or accumulation has been detected. In this way, the continuous operation of the separating device is further automated, and energy saved, by the coil only being operated when it is necessary.

A magnetizable element, in particular a plate, may be arranged between the permanent magnet and the separating channel. Such a plate is always advisable if there is excessive proximity, and consequently an excessive magnetic field gradient, in the vicinity of the separating channel wall that cannot be completely weakened even by making current flow through the coil to the extent that a clumping or accumulation of magnetizable particles breaks up. However, such a plate may also be configured with respect to another advantageous effect. For instance, it may be provided that the element has a convexly curved or trapezoidal form toward the separating channel. In this way, the side area is minimized, so that less stray losses occur.

As an alternative, to avoid stray losses by minimizing the side areas, a configuration of the separating device in which a surface of the magnet that is facing the separating channel has a convexly curved or trapezoidal form may also be provided. In this case, the surface of the permanent magnet is therefore adapted itself.

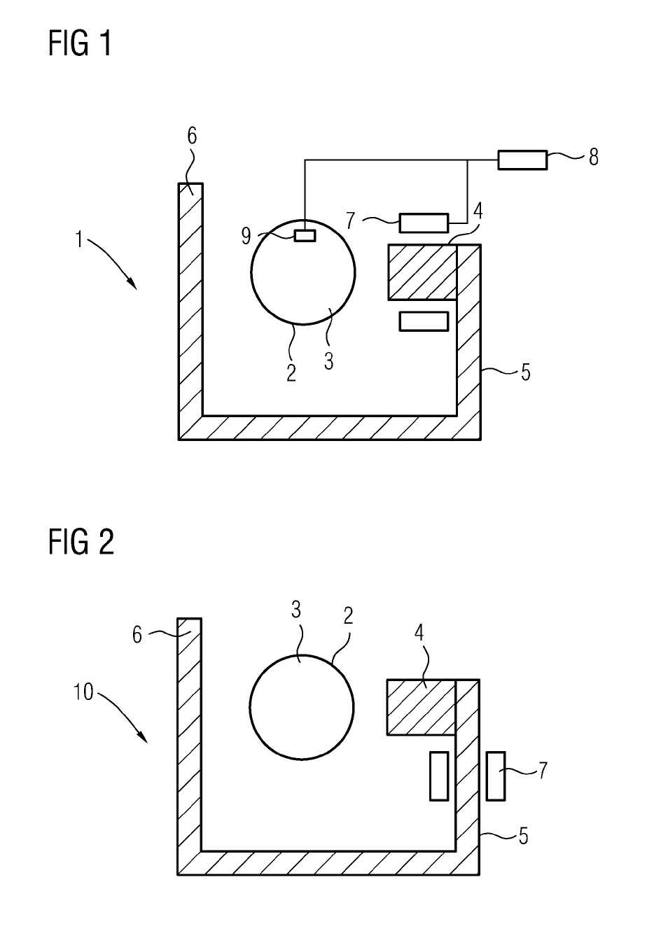

FIG. 1 shows a separating device 1 according to various embodiments. A tube 2, which runs perpendicularly to the plane of the image, defines a separating channel 3, which is charged with a suspension which contains magnetizable particles and non-magnetizable particles. A permanent magnet 4, which generates a permanent magnetic field that is always present, is provided to one side of the separating channel 3. The magnetic circuit is closed with respect to the side of the separating channel 3 that is opposite from the permanent magnet 4 by a yoke 5 of iron, the leg 6 of the yoke 5 being formed in such a way that it extends beyond the separating channel 3 to increase the surface area opposite the permanent magnet 4 to improve the field properties.

The separating device 1 further comprises a coil 7, the turns of which run around the permanent magnet 4. This coil 7 can be used to weaken or strengthen the permanent magnetic field, which acts inside the separating channel 3 as a deflecting magnetic field, either statically by applying a constant current or else variably over time.

In the present case it is provided for the separating device 1 that a current variable over time is made to flow through the coil 7. Serving to control the coil 7 is a control device 8, which is connected to the coil 7.

Consequently, it is generally possible to vary, meaning to strengthen or weaken, the deflecting magnetic field in the separating channel 3 according to the situation. The combination of the permanent magnet 4 with the coil 7 flowed through by current allows the advantages of the individual systems to be used, that is to say a magnetic deflecting field can be built up by the permanent magnet 4 without constantly having to supply electrical energy, and without heat loss constantly occurring, while an additional magnetic field that is variable over time can be generated by the coil. By using the control device 8 to control what happens, the combination provides the possibility of generating a deflecting magnetic field that is variable over time and adapted to the separating process and to limit the energy requirement of the components. For this purpose, the components comprising the permanent magnet 4 and the coil 7 must be made to match one another well, the coil current being controlled or regulated over time by means of the control device 8. The coil current may in this case be regulated, for example, on the basis of operating parameters and/or user inputs, so that, for example, the deflecting magnetic field is strengthened when separating particularly large particles, while the field is weakened when there is a very slow rate of flow through the separating channel 3, and so on.

In particular, however, the problem occurring in the case of such separating devices 1 of magnetizable particles clumping or being deposited on the tube wall 2 in the separating channel 3 as a result of the strong forces of attraction toward the permanent magnet can also be combated by the control device 8 making current flow through the coil 7 in such a way that particles that have accumulated on the tube wall can become detached again, in particular also assisted by the flow, and thus can be transported further. In this way, a continuous operating process can be achieved.

This can, in principle, take place by a weakening of the deflecting magnetic field taking place, for example at fixed time intervals, by current being made to flow correspondingly through the coil 7. In the present exemplary embodiment, however, sensors 9, which are similarly connected to the control device 8 and can detect a clumping and/or deposits of magnetizable particles, are additionally provided on or in the separating channel. In response to a corresponding signal from the sensor 9, the control device 8 then controls the coil 7 in such a way that the accumulation or clumping can be dispersed again, ideally already at the stage of inception.

It should be noted at this point that what has been said here about the control of the at least one coil 7 by the control device 8 can also be applied of course to the exemplary embodiments described below, even if the way in which they are controlled is no longer discussed in detail there.

For instance, FIG. 2 shows a second exemplary embodiment of a separating device 10, to simplify matters components that are the same being designated by the same reference numerals here and hereafter. As a difference from the separating device 1, in the case of the separating device 10 the coil 7 is not wound around the permanent magnet 4 but is placed offset around the yoke 5. It is also possible in this way for the deflecting magnetic field to be correspondingly influenced.

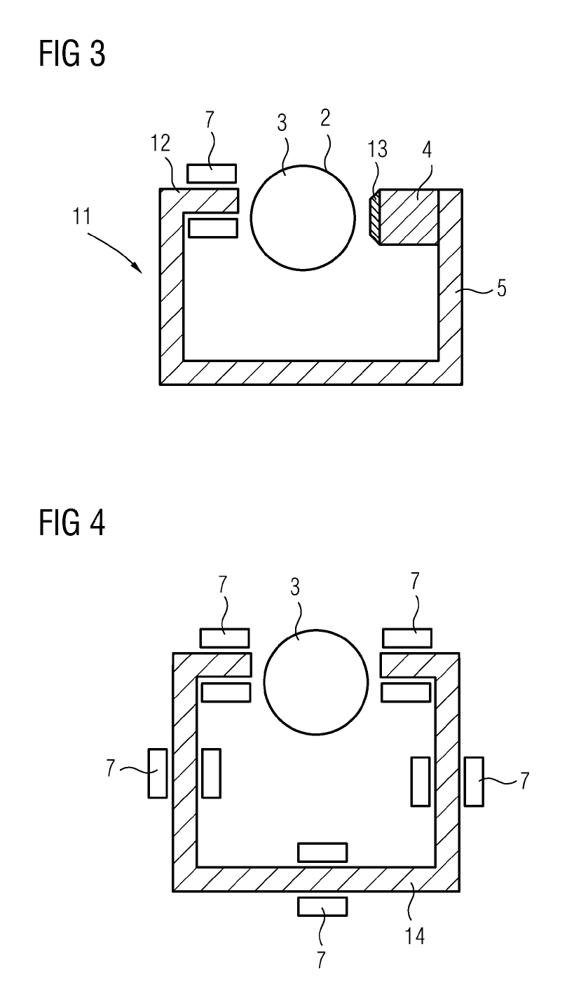

FIG. 3 shows a third exemplary embodiment of a separating device 11. Here, the yoke 5 is formed in such a way as to obtain a yoke leg 12 that is symmetrical to the cylindrical permanent magnet 4 and reaches up to the separating channel 3 or the tube 2 from the other side. If merely one such a symmetrically configured yoke leg 12 is provided on the yoke 5, it has been found that, although a certain strengthening of the deflecting magnetic field occurs as a result of the yoke 5, a symmetrical deflecting magnetic field is not obtained, since parts of the field that draw the field of the leg 12 widthwise also already escape on the upper side and the underside of the leg 12.

The separating device 11 also comprises a coil 7, the turns of which here run around the leg 12. Also in such a case there are many possibilities for influencing the deflecting magnetic field by making current flow correspondingly through the coil 7. For instance, it is possible to make current flow through the coil 7 in such a way that it ultimately acts like a second permanent magnet 4 and a symmetrical field distribution of the deflecting magnetic field is obtained, a field distribution in which magnetizable particles can be deflected both toward the leg 12 and toward the permanent magnet 4. In this way, the separating effect is intensified. However, current may also be made to flow through the coil 7 in such a way that, as it were, it forces back the field of the permanent magnet 4, and minimizes the deflecting forces inside the separating channel to such an extent that, for example, accumulations and clumpings of magnetizable particles can break up.

The control may in this case take place as already described above.

The separating device 11 further comprises a plate 13 arranged between the permanent magnet 4 and the separating channel 3, serving two purposes. On the one hand, it keeps the permanent magnet 4 at a distance from the separating channel 3 and thereby creates a “buffer zone”, into which the magnetic field of the permanent magnet 4 can be forced back when there is a desired weakening of the deflecting magnetic field in the separating channel 3. On the other hand, the plate 13 is formed trapezoidally toward the separating channel 3, so that the side area is minimized, and consequently stray losses are reduced. In order to achieve the last-mentioned effect, it is also possible incidentally, instead of having a plate 13 of iron, to form the surface of the permanent magnet 4 that is facing the channel 3 correspondingly.

Even if only one permanent magnet 4 and one coil 7 are respectively shown in the exemplary embodiments mentioned up until now, this does not mean that there is any restriction to such embodiments. It is also possible for a number of permanent magnets 4 and/or a number of coils 7 to be provided. For example, an arrangement in which a further permanent magnet 4 is provided instead of the leg 12 in FIG. 3 and a further coil 7 surrounds the permanent magnet 4 arranged on the right in FIG. 3 is conceivable.

FIG. 4 then shows in the form of a basic diagram further possibilities for arranging one or more coils 7 along the closed magnetic circuit 14. It can be seen that many configurations are conceivable.

What is claimed is:

1. A separating device for separating magnetizable particles and non-magnetizable particles transported in a suspension flowing through a separating channel, comprising:
at least one permanent magnet arranged on at least one side of the separating channel for generating a magnetic field which deflects magnetizable particles to said at least one side, wherein, in addition to the permanent magnet, at least one coil is provided for generating an additional field.

2. The separating device according to claim 1, wherein the coil is configured such that current can flow through it to generate a magnetic field that strengthens the deflecting magnetic field.

3. The separating device according to claim 1, wherein the coil is configured such that current can flow through it to generate a magnetic field that weakens the deflecting magnetic field.

4. The separating device according to claim 1, wherein the or a coil is arranged so as to surround the permanent magnet.

5. The separating device according to claim 1, wherein the or a coil is arranged around a yoke connected to the permanent magnet.

6. The separating device according to claim 5, wherein the or a coil is arranged on the yoke on a side of the separating channel that is opposite from the permanent magnet.

7. The separating device according to claim 1, wherein a control device is provided for controlling the coil.

8. The separating device according to claim 7, wherein at least one sensor is provided, connected to the control device and detecting a clumping or accumulation of magnetizable particles in the separating channel, the control device being designed to make a current flow through the coil to weaken the deflecting magnetic field in response to a signal indicating clumping or accumulation.

9. The separating device according to claim 1, wherein a magnetizable element is arranged between the permanent magnet and the separating channel.

10. The separating device according to claim 9, wherein the element has a convexly curved or trapezoidal form toward the separating channel.

11. The separating device according to claim 1, wherein a surface of the permanent magnet that is facing the separating channel has a convexly curved or trapezoidal form.

12. The separating device according to claim 9, wherein the magnetizable element is a plate.

13. A method for separating magnetizable particles and non-magnetizable particles transported in a suspension flowing through a separating channel, comprising:
arranging at least one permanent magnet on at least one side of the separating channel for generating a magnetic field which deflects magnetizable particles to said at least one side, and
generating an electrical field by at least one coil arranged next to said permanent magnet.

14. The method according to claim 13, further comprising feeding a current through the coil to generate a magnetic field that strengthens the deflecting magnetic field.

15. The method according to claim 13, further comprising feeding a current through the coil to generate a magnetic field that weakens the deflecting magnetic field.

16. The method according to claim 13, further comprising arranging the or a coil so as to surround the permanent magnet.

17. The method according to claim 13, further comprising arranging the or a coil around a yoke connected to the permanent magnet.

18. The method according to claim 17, further comprising arranging the or a coil on the yoke on a side of the separating channel that is opposite from the permanent magnet.

19. The method according to claim 13, further comprising detecting a clumping or accumulation of magnetizable particles in the separating channel, and feeding a current flow through the coil to weaken the deflecting magnetic field in response to a signal indicating clumping or accumulation.

20. The method according to claim 13, further comprising arranging a magnetizable element between the permanent magnet and the separating channel.
